(19) United States
(12) Patent Application Publication
(10) Pub. No.: US 2009/0007788 A1
(43) Pub. Date: Jan. 8, 2009

(54) Method and device for electrostatic cleaners

(76) Inventors: Noam Arye, Ashdod (IL); Daniel Nir-Nemenyi, Tel Aviv (IL); Dov Rothfeld, Raanana (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/824,330

(22) Filed: Jul. 2, 2007

(51) Int. Cl. B03C 3/38; B03C 3/40; B03C 3/41; B03C 3/45; B03C 3/47

(52) U.S. Cl. 96/40; 96/28; 96/51

(57) ABSTRACT

An electrostatically charged rotating plate or cylinder is used to attract electrostatically charged particles in smoke to avoid pollution and improve the efficiency of the filtering process. The rotating plate is constantly cleaned from the ionized particles adhering to it and the particles so collected are removed without polluting the environment. This filtering system reduces capital and running costs compared with the present filtering systems.

### FIELD OF THE INVENTION

This invention is in the field of civil engineering, particularly in the cleansing of smoke emissions from industrial plants. In particular, the invention assists in reducing harmful particle emissions from electricity generating utilities.

### BACKGROUND OF THE INVENTION

It is well known that smoke and the microscopic particles found within the smoke are a major cause of air pollution. This pollution can be hazardous to health, especially to the elderly as well as bronchial and asthma sufferers. In order to minimize these hazards and dangers, legislation has been enacted forcing air polluting industries to actively find ways of minimizing air pollution to an acceptable level.

Amongst the methods used are electrostatic filters which remove the microscopic particles found within the smoke. The smoke-laden air ejected by the turbines firstly passes across negatively-charged electrodes, the particles become ionized and then, as they pass the positively charged plates become attracted, like a magnet, to these plates and become deposited on them. The plates eventually become filled with the ionized particles and the efficiency of the absorption diminishes considerably and the filters then require periodic cleaning. This method is not very efficient as it requires a large number of plates. In addition, the present system of cleaning involves mechanical cleaning methods that are unsatisfactory as they use a large amount of energy to shake, or “rap,” the plates for cleaning. Another disadvantage of the currently used cleaning methods is that through this cleaning process, particles are released into the atmosphere, thus causing a considerable amount of pollution. It has been reported that power plants release into the atmosphere around 150 tons of particles per day, which is over 50,000 tons per year! In fact, the offices of the Environmental or Pollution Control Authorities sometimes require the electric company to obtain permission from them before carrying out the “cleaning” process of these plates. Present day units typically comprise many collection plates, with a very large surface area.

Furthermore, the filters used in the state of the art apparatus cause a resistance to the flow of exhaust gases. This is a disadvantage as the uninterrupted flow of these gases increases the efficiency of the power plant as a whole.

Present day units have a holed plate at the entrance to the filter system to cause the smoky air to be evenly distributed. This plate causes resistance to the airflow and some power plants install fans after the plate to increase the air flow. What is needed therefore is a system that cleans the collection plates without causing pollution, and a system where the plates are cleaned while in place and in use. What is further needed is that the space required for the collection plates in the emission chimneys be greatly reduced. Also needed is a filtering system that does not interfere with the flow of polluted air as it passes through the filtering system.

For the above reasons and more, it can be seen that there will be considerable demand for this invention by the power generating industry and by environmentally conscious governments.

### SUMMARY OF THE INVENTION

It is to be understood that both the foregoing general description and the following detailed description present embodiments of the invention and are intended to provide an overview, or framework, for understanding the nature and character of the invention as it is claimed. The accompanying drawings are included to provide a further understanding of the invention, and are incorporated into and constitute part of this specification. The drawings illustrate various embodiments of the invention and together with the description serve to explain the principles and operations of the invention.

The new improved electrostatic filter of this invention employs the same basic principle as that used today. That is to say, the smoke-laden emission gas passes over negatively charged electrodes, the particles in the smoke become negatively ionized and are then attracted to the positively charged plates. This invention employs rotary plates which rotate at a speed close to that of the smoke-laden emission gas that passes by the said rotary plates. The smoke particles, having previously been ionized by a high voltage electrical charge, pass through the negatively charged electrodes and are attracted to and deposited on the positively charged rotating plates. The rotating plates can be of a smaller surface area than a fixed plate since it is constantly being cleaned and also because of the comparable speed of the rotating plates and the smoke. The rotating plate is contained partially within a closed box and thus the particles, after having been removed by a brush, will not be released back into the environment. The particles will instead be deposited at the bottom of a box where a collection hopper is located.

An advantage of this invention is that this unit does not have to be taken out of service for cleaning, as it is constantly being cleaned.

Another advantage of this invention is an improvement of the present filtering method, as it is so designed that there is negligible build-up of particles on the collection plates because they are being constantly cleaned.

Additionally, the space required for such units with the equivalent filtering capacity is greatly reduced.

This will allow for greater efficiency of smoke and particle cleansing. At the same time manufacturing costs are lowered because the unit is considerably smaller than present day units and running costs are greatly reduced.

Furthermore, the cleaning process takes place while the gases are being emitted, thereby avoiding the need to house additional sets of plates or having to wait until the gases cease to flow from a particular emission tower or having to wait for environmental officers' approval to clean the plates before carrying out the cleaning process. As a result of the constant cleaning process there is negligible spraying of carbon particles into the atmosphere.

A further way of removing carbon particles from the ionized filter drums is by acoustic methods. The vibration of certain pitches of sounds causes the particles to be released from the filter and fall into the collection container.

All these factors contribute to the production of electricity at power plants, with greater efficiency, increased uninterrupted production time, lower capital costs, lower running costs and a vast improvement of the state of the surrounding environment.

### BRIEF DESCRIPTION OF DRAWINGS

The accompanying drawings, which are incorporated in and form a part of this specification, illustrate embodiments of the invention and, together with the description, serve to explain, by way of example only, the principles of the invention:

FIG. 1 shows a schematic sectional view of the electrostatic cleaner of this invention.

FIG. 2 shows the same device from the plan view.

FIG. 3 shows another embodiment of this invention from the sectional view.

FIG. 4 shows the embodiment of FIG. 3 from the plan view.

### DESCRIPTION OF PREFERRED EMBODIMENTS

As will be appreciated, the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

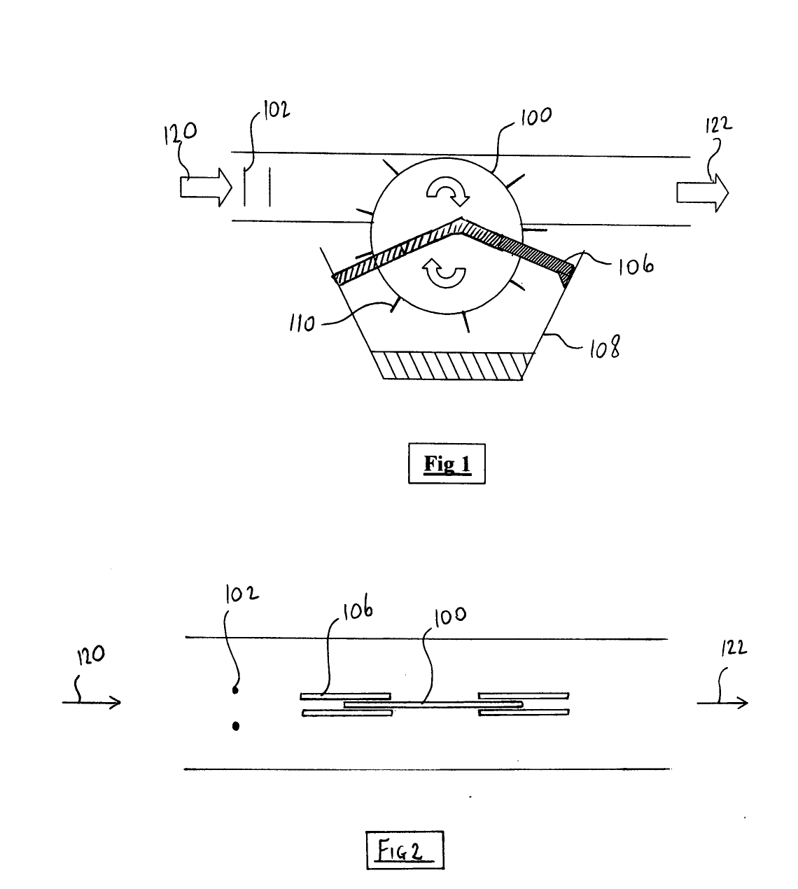

FIG. 1 shows the improved electrostatic smoke cleaner from the sectional view. A positively-charged rotating plate 100, negatively charged electrodes 102, a collection hopper 108 and fixed brushes 106.

The particle-laden smoke enters the electrostatic cleaner from the direction of the arrow 120 and flows through the negatively charged electrodes 102. The smoke particles are now negatively ionized and continue flowing through the cleaner until they pass by the positively charged circular plate 100.

The positively charged circular plate 100 rotates in the same direction and at a speed close to that of the smoke passing over it. The continuous rotation and cleansing of the plate 100 will expose constantly to the polluted smoky air a clean positively charged surface. Thus, only a thin layer of negatively charged particles will accumulate on the plate 100. As the plate 100 rotates, it is cleaned by the cleaning brushes 106 and the particles fall into the bottom of the collection hopper 108 from where they are collected and disposed of.

The cleaned smoke is then vented out of the electrostatic cleaner in the direction of arrow 122.

Another advantage of this invention is that the collection hopper 108 is sealed, thus the particles are not released back into the air-flow, but instead drop to the bottom of hopper 108.

The collection plate 100 can have small fins 110 on its edges so that the smoke passing through will drive and rotate the collection plate 100. Thus, no extra cost would be entailed in order to rotate the collection plate 100.

Optionally a small electric motor could be used to rotate the plate 100 at the required speed.

FIG. 2 shows the electrostatic smoke cleaner from the plan view. The particle filled smoke enters from the direction shown by the arrow 120. The particles are negatively charged by passing by the electrodes 102 and are attracted to the positively charged cleaning disc 100. The disc 100 rotates and the brushes 106 constantly clean the disc by means of the disc's rotating movement.

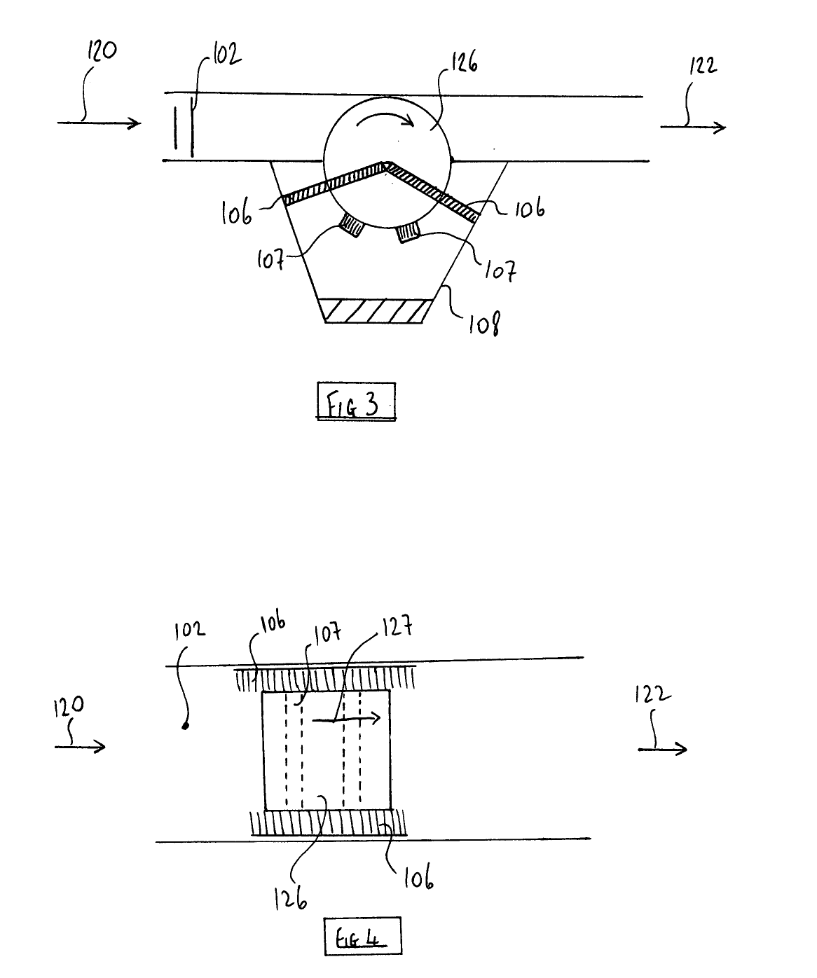

FIG. 3 shows the sectional view of a different embodiment of the electrostatic cleaner, the main difference from the embodiment described in FIG. 1 is the shape of the disc. In this embodiment the charged cleaning device is a cylinder-shaped drum 126 closed at both ends. The drum 126 exposes more surface area and therefore attracts more particles onto its surface. The brushes 106 clean the ends of the drum 126 in a similar way to the cleaning of the disc FIG. 1 100. The brushes 107 rest against and touch the drum 126 along its length so that when the drum rotates, the brushes 107 clean off any particles that have been attracted to drum 126.

In other respects this embodiment works in a similar way to that in FIG. 1 and FIG. 2. The particle filled smoke flows in the direction of the arrow 120 passing the electrodes 102 which charge the smoke particles with a negative ionization. The drum 126 is charged with a positive charge and thereby attracts the said particles onto its surface. The drum 126 turns either by the inertia of the air moving past it, with or without fins as described in FIG. 1 110, or with the aid of a motor.

The brushes 106 and 107 clean off the particles from the surface of the drum 126. The particles fall to the bottom of the hopper 108 and are periodically removed therefrom.

The cleaned air flows in the direction of arrow 122.

FIG. 4 shows the embodiment in FIG. 3 from the plan view. The smoke flows in the direction of the arrow 120 past the electrodes 102 over the drum 126 and out in the direction of the arrow 122. The drum turns on its central axis in the direction of arrow 127 and the brushes 106 at each end of the drum 126 clean off the particles. The brushes 107 under the drum 126 are shown with a broken line as they are not ordinarily visible from the plan view.

The present invention is not intended to be limited to the embodiments described above, but to encompass any and all embodiments within the scope of the following claims.

1. An electrostatic air cleaner comprising;
a) at least one electrode for ionizing particles in particle filled air,
b) at least one revolving circular disc charged with the opposite charge from the said particles and having its upper portion exposed to the said particle-filled air,
c) a means to remove the said particles electrostatically attached to the said disc from the lower portion of the said disc, and
d) a hopper to collect the said removed particles whereby air containing particles is cleaned and the said particles are disposed of without entering the atmosphere and whereby the said disc is continuously cleaned from the said particles.

2. An electrostatic air cleaner as claimed in claim 1 wherein the said disc revolves around its central axis powered by the force of the moving air passing by the said disc.

3. An electrostatic air cleaner as claimed in claim 1, further comprising fins protruding from the said disc whereby the said fins aid the turning of the said disc as the air passes it by.

4. An electrostatic air cleaner as claimed in claim 1 further comprising a motor to assist the said disc to revolve.

5. An electrostatic air cleaner as claimed in claim 1 wherein the means of removing the said particles electrostatically attached to the lower portion of the said disc is by at least one brush whose bristles touch the lower portion of the said disc across its radius from the perimeter to the center of the said disc.

6. An electrostatic air cleaner as claimed in claim 1 wherein the said hopper is sealed from exposure to the said air.

7. An electrostatic air cleaner as claimed in claim 1 wherein the said hopper is capable of being emptied from the accumulated particle deposits while the said disc is rotating.

8. An electrostatic air cleaner as claimed in claim 1 wherein the said disc is a shape other than a disc.

9. An electrostatic air cleaner as claimed in claim 1, further comprising an instrument for producing acoustic sounds towards the direction of the said disc.

10. An electrostatic air cleaner comprising;
a) at least one electrode for ionizing particles in particle-filled air,
b) at least one revolving cylindrical drum charged with the opposite charge from the said particles and having its upper portion exposed to the said particle-filled air,
c) a means to remove the said particles electrostatically attached to the said drum from the lower portion of the said drum, and
d) a hopper to collect the said removed particles whereby air containing particles is cleaned and the said particles are disposed of without entering the atmosphere and whereby the said drum is continuously cleaned from the said particles.

11. An electrostatic air cleaner as claimed in claim 10 wherein the said drum revolves around its central axis powered by the force of the moving air passing it by.

12. An electrostatic air cleaner as claimed in claim 10, further comprising fins protruding from the said disc whereby the said fins aid the turning of the said drum as the air passes it by.

13. An electrostatic air cleaner as claimed in claim 10, further comprising a motor to assist the said drum to revolve.

14. An electrostatic air cleaner as claimed in claim 10 wherein the means of removing the said particles electrostatically attached to the lower portion of the said drum is by at least one brush whose bristles touch the lower portion of the said drum at the two ends of the said drum across the radius of the said ends from the perimeter to the center of the said drum and at least one brush whose bristles touch the said drum along the length of the said drum.

15. An electrostatic air cleaner as claimed in claim 10 wherein the said hopper is sealed from exposure to the said air.

16. An electrostatic air cleaner as claimed in claim 10 wherein the said hopper is capable of being emptied from the accumulated particle deposits while the said drum is operating.

17. An electrostatic air cleaner as claimed in claim 10 wherein the said drum is a shape other than a cylinder.

18. An electrostatic air cleaner as claimed in claim 10, further comprising an instrument for producing acoustic sounds towards the direction of the said drum.
